(19) United States
(12) Patent Application Publication
(10) Pub. No.: US 2026/0261644 A1
(43) Pub. Date: Sep. 3, 2026

(54) SYSTEM FOR TESTING THREE-DIMENSIONAL IMAGING EFFECTS AND METHOD, DEVICE, AND STORAGE MEDIUM

(71) Applicant: TENCENT TECHNOLOGY (SHENZHEN) COMPANY LIMITED, Shenzhen (CN)

(72) Inventors: Sen YANG, Shenzhen (CN); Minhua YE, Shenzhen (CN)

(21) Appl. No.: 19/656,691

(22) Filed: Apr. 23, 2026

Related U.S. Application Data
(63) Continuation of application No. PCT/CN2025/077383, filed on Feb. 14, 2025.

(30) Foreign Application Priority Data
Feb. 20, 2024 (CN) 202410190343.2

(51) Int. Cl. H04N 13/327; H04N 13/00; H04N 13/239; H04N 13/296; H04N 13/31; H04N 13/383; H04N 13/398

(52) U.S. Cl. CPC H04N 13/327; H04N 13/239; H04N 13/296; H04N 13/31; H04N 13/383; H04N 13/398; H04N 2013/0096

(57) ABSTRACT

This application relates to the field of imaging effect testing, and discloses a system for testing three-dimensional imaging effects. The system includes a head model, a binocular camera provided at eye positions of the head model, and a computing component connected to the binocular camera, the binocular camera being configured to photograph a three-dimensional image displayed or rendered on a three-dimensional display device, to obtain a first left-eye image and a first right-eye image; and the computing component being configured to output imaging effect information of the three-dimensional display device based on the first left-eye image and the first right-eye image.

### RELATED APPLICATIONS

This application is a continuation of PCT Application No. PCT/CN2025/077383, filed on Feb. 14, 2025, which claims priority 2024, Chinese Patent Application No. 202410190343.2, filed on Feb. 20, 2024, and entitled “TESTING SYSTEM FOR THREE-DIMENSIONAL IMAGING EFFECTS AND METHOD, DEVICE, AND STORAGE MEDIUM”, which are both incorporated herein by reference in their entirety.

### FIELD OF THE TECHNOLOGY

Embodiments of this application relate to the field of imaging effect testing, and in particular, to a testing system for three-dimensional imaging effects and method, a device, and a storage medium.

### BACKGROUND OF THE DISCLOSURE

With development of autostereoscopic display technologies, users have higher requirements on visual experience of viewing three-dimensional images with naked eyes. The autostereoscopic display technology is a technology in which, without the need for a user to wear three-dimensional glasses, an autostereoscopic display device synthesizes a three-dimensional visual image based on detected eye positions of a viewer, so that a viewer can perceive a stereoscopic effect when viewing the three-dimensional visual image.

In many cases, an imaging effect of the autostereoscopic display device needs to be tested. The following testing methods are often used: 1. Viewer survey: perceptions and evaluations of viewers on a stereoscopic effect of a three-dimensional visual image are surveyed by using tools such as questionnaire surveys, oral feedback, or rating systems. 2. Depth perception testing: A stereoscopic effect is evaluated by allowing a viewer to determine a distance, a size, or a position relationship of an object in a three-dimensional visual image. 3. Stereoscopic fusion testing: Stereoscopic fusion refers to a process in which, when a viewer views a three-dimensional visual image, images viewed by left and right eyes are fused to form a complete stereoscopic image. A stereoscopic fusion speed and fusion quality of the viewer in a viewing process is measured by allowing the viewer to view some scenes or objects that are difficult to fuse. 4. Physiological indicator measurement: Physiological indicators, such as pupil dilation and a focus change, of a viewer when the viewer views a three-dimensional visual image is measured by using a professional instrument.

A testing method provided in related art relies on subjectivity, health conditions, and the language expression capability of the viewer, and there are also substantial deviations in physiological indicator data collection. As such, objective indicator evaluation cannot be performed on a stereoscopic effect of a three-dimensional visual image, and there is a lack of an objective quantitative standard measuring the quality of the stereoscopic effect.

### SUMMARY

This application provides a testing system for three-dimensional imaging effects and method, a device, and a storage medium, to evaluate an imaging effect of a three-dimensional display device based on objective data. The technical solutions are as follows.

One aspect of this application provides a system for testing three-dimensional imaging effects, including a head model, a binocular camera provided at eye positions of the head model, and a computing component connected to the binocular camera, the binocular camera being configured to photograph a three-dimensional image displayed or rendered on a three-dimensional display device, to obtain a first left-eye image and a first right-eye image; and the computing component being configured to output imaging effect information of the three-dimensional display device based on the first left-eye image and the first right-eye image.

Another aspect of this application provides A head model configured for testing three-dimensional imaging effects with a binocular camera being provided at eye positions of the head model, wherein the binocular camera is configured to photograph a three-dimensional image displayed or rendered on a three-dimensional display device to obtain a first left-eye image and a first right-eye image, and the first left-eye image and the first right-eye image are configured for generating imaging effect information of the three-dimensional display device. Another aspect of this application provides a method for testing three-dimensional imaging effects, performed by a computing component. The method includes obtaining a first left-eye image and a first right-eye image, the first left-eye image being obtained by a left camera of a binocular camera photographing a three-dimensional image, the first right-eye image being obtained by a right camera of the binocular camera photographing the three-dimensional image, the binocular camera being located at eye positions of a head model, and the three-dimensional image being displayed or rendered by a three-dimensional display device; and outputting imaging effect information of the three-dimensional display device based on the first left-eye image and the first right-eye image.

Another aspect of this application provides a computer device is provided and includes a processor and a memory, the memory having a computer program stored therein, and the computer program being loaded and executed by the processor to implement the foregoing three-dimensional imaging effect testing method.

Another aspect of this application provides a non-transitory computer-readable storage medium is provided and has a computer program stored therein, the computer program being loaded and executed by a processor to implement the foregoing three-dimensional imaging effect testing method.

In this application, a scenario in which a real person views a three-dimensional image is simulated by using a head model and a binocular camera located at eye positions of the head model. The binocular camera can collect objective data (first left-eye and right-eye images), and a computing component may subsequently evaluate a three-dimensional imaging effect based on the objective data, to quantify the three-dimensional imaging effect. In other words, in this application, reliance on subjective perceptions of actual viewers who have viewed the three-dimensional visual image is avoided. In related art, a three-dimensional imaging effect is evaluated based on subjective perceptions, which is easily affected by the ability to communicate and a cognition level of a viewer, resulting in non-standardized evaluation for the three-dimensional imaging effect.

In addition, in this application, the three-dimensional imaging effect is evaluated based on the collected objective data, to provide objective reference for subsequent software and hardware improvement of the three-dimensional display device. In addition, this application provides a solution to support testing of imaging capability of a wide range of three-dimensional display devices. The testing system is simple, requires no additional development and customization work, and can accurately and objectively evaluate a three-dimensional imaging effect under any evaluation standard.

In addition, a binocular camera in related art is configured to photograph an image and further determine depth information of an object in the image. However, in this application, the imaging effect of the three-dimensional display device is further evaluated based on the first left-eye image and the first right-eye image that are photographed by the binocular camera. The binocular camera in related art and the binocular camera in this application have different functions.

### BRIEF DESCRIPTION OF THE DRAWINGS

FIG. 1 is a schematic diagram of a testing system for three-dimensional imaging effects according to one embodiment.

FIG. 2 is a schematic diagram of a testing system for three-dimensional imaging effects according to another embodiment.

FIG. 3 is a schematic diagram of a head model according to one embodiment.

FIG. 4 is a schematic diagram of a head model according to another embodiment.

FIG. 5 is a schematic diagram of a testing system for three-dimensional imaging effects according to another embodiment.

FIG. 6 is a schematic diagram of a binocular parallax computing method according to one embodiment.

FIG. 7 is a schematic diagram of a head model according to an embodiment.

FIG. 8 is a flowchart of a system for testing three-dimensional imaging effects according to one embodiment.

FIG. 9 is a flowchart of a method for testing three-dimensional imaging effects according to another embodiment.

FIG. 10 is a flowchart of a method for testing three-dimensional imaging effects according to another embodiment.

FIG. 11 is a flowchart of a method for testing three-dimensional imaging effects according to another embodiment.

FIG. 12 is a block diagram of a structure of a three-dimensional imaging effect testing apparatus according to one embodiment.

FIG. 13 is a block diagram of a structure of a computing component according to one embodiment.

### DESCRIPTION OF EMBODIMENTS

First, related terms in this application are briefly described below.

Three-dimensional display device: The three-dimensional display device is a device supporting display of a three-dimensional visual image. In some embodiments, three-dimensional display devices include an autostereoscopic display device and a non-autostereoscopic display device. The autostereoscopic display device is a device enabling a user to view a three-dimensional visual image with naked eyes. The user can view the three-dimensional visual image without using an auxiliary tool, and the autostereoscopic display device provides more convenient visual experience for the user. The non-autostereoscopic display device includes a display device using three-dimensional glasses/a three-dimensional helmet. In some embodiments, the autostereoscopic display device includes a display device provided with a radial semi-conical lenticular grating outside a screen.

Autostereoscopic display device: The autostereoscopic display device is logically different, in an underlying architecture, from a display device using three-dimensional glasses. The autostereoscopic display device additionally performs eye detection. The autostereoscopic display device renders a three-dimensional visual image in real time by using a prism grating or an electronic grating, and presents a three-dimensional visual effect at eye positions of a viewer. Therefore, three-dimensional rendering delays and synthesis inefficiency are exacerbated, and changes in eye positions and angles of the viewer easily cause ghosting and blurring. As a result, it is difficult to apply and popularize the autostereoscopic display device.

In some scenarios, a radial semi-conical lenticular grating is provided outside a screen of the display device, so that a left eye of the viewer views an image photographed from a left viewing angle and a right eye of the viewer views an image photographed from a right viewing angle. The radial semi-conical lenticular grating projects, according to an optical principle, the image photographed by a camera from the left viewing angle to the left eye of the viewer, and projects the image photographed by the camera from the right viewing angle to the right eye of the viewer.

Non-autostereoscopic display device: In some scenarios, a viewer may further see a three-dimensional visual image by using an auxiliary device, for example, three-dimensional glasses. The three-dimensional glasses include red-blue glasses, polarized glasses, or the like. For the red-blue glasses, a left-eye lens is a red lens, and a right-eye lens is a blue lens. The red lens filters out blue light, and a left eye only sees red light. The blue lens filters out red light, and a right eye only sees blue light. In this case, the left and right eyes see different images to achieve a stereoscopic effect.

For the polarized glasses, a left-eye lens is a horizontal polarizing filter that transmits horizontally polarized light, and a right-eye lens is a vertical polarizing filter that transmits vertically polarized light. In this case, the left and right eyes see different images to achieve a stereoscopic effect.

In some embodiments, the three-dimensional visual image is obtained by synthesizing an image photographed by a first camera and an image photographed by a second camera. The image photographed by the first camera represents an image photographed from a left viewing angle, and the image photographed by the second camera represents an image photographed from a right viewing angle.

Binocular parallax: The binocular parallax is a horizontal displacement between a position of an object seen by a left eye and a position of an object seen by a right eye. Differences in an interpupillary distance and a gaze angle of both eyes result in a horizontal difference between physical images formed on retinas of the left eye and the right eye. When a stereoscopic object is observed, due to a distance between both eyes, both eyes observe the same object from different angles. Such a slight horizontal parallax that occurs in images formed on the retinas of both eyes is referred to as a binocular parallax or a stereoscopic parallax.

FIG. 1 is a schematic diagram of a system for testing three-dimensional imaging effects according to an embodiment of this application. The system for testing three-dimensional imaging effects 100 includes: a head model 101, a binocular camera 102 provided at eye positions of the head model 101, and a computing component 103 connected to the binocular camera 102. In some embodiments, the binocular camera 102 is connected to the computing component 103 in a wired or wireless manner.

The binocular camera 102 is configured to photograph a three-dimensional visual image 13 displayed or rendered by a three-dimensional display device 104. Presentation may be understood as displaying, playback, or projecting. A left camera of the binocular camera 102 photographs a first left-eye image 111, and a right camera of the binocular camera 102 photographs a first right-eye image 121. The binocular camera 102 transmits the photographed first left-eye image 111 and first right-eye image 121 to the computing component 103.

The computing component 103 is configured to output imaging effect information of the three-dimensional display device based on the first left-eye image 111 and the first right-eye image 121. The imaging effect information includes indicator values configured for measuring an imaging effect of the three-dimensional display device. For example, the imaging effect information may be a binocular parallax error and the like. The imaging effect information may include a binocular parallax error, a pixel value offset, an object contour offset, and the like. The binocular parallax error is configured for measuring a degree of ghosting of an image. The binocular parallax error refers to an error between a binocular parallax of an image before synthesis and a binocular parallax of an image photographed by the binocular camera 102. If the binocular parallax error is large, the degree of ghosting is high. The pixel value offset is configured for measuring a degree of blurring of an image. If a change in pixel values between the image before synthesis and the image photographed by the binocular camera 102 is large, the degree of blurring of the image is high. The object contour offset refers to a variation between a contour of an object in the image before synthesis and a contour of an object in the image photographed by the binocular camera 102. If the object contour offset is large, a degree of deformation of an object is large.

In some embodiments, the three-dimensional display device 104 is an autostereoscopic display device. In some embodiments, the head model 101 is a human head model, an animal head model, an animation character head model, or the like. The autostereoscopic display device captures a position of the head model 101, and estimates eye positions of the head model 101. Alternatively, the autostereoscopic display device 104 captures a position of the binocular camera in the head model 101, and uses the position as the eye positions. The autostereoscopic display device synthesizes, based on the eye positions, two-dimensional images photographed by a camera from left and right viewing angles, to obtain the three-dimensional visual image 13. The autostereoscopic display device allows a viewer to perceive the same or substantially the same three-dimensional visual effect with naked eyes at different positions.

In some embodiments, the autostereoscopic display device includes a display screen, and a radial semi-conical lenticular grating disposed in front of the screen. The radial semi-conical lenticular grating projects, according to an optical principle, an image photographed by a camera from a left viewing angle to a left eye of the head model 101, and projects an image photographed by the camera from a right viewing angle to a right eye of the head model 101.

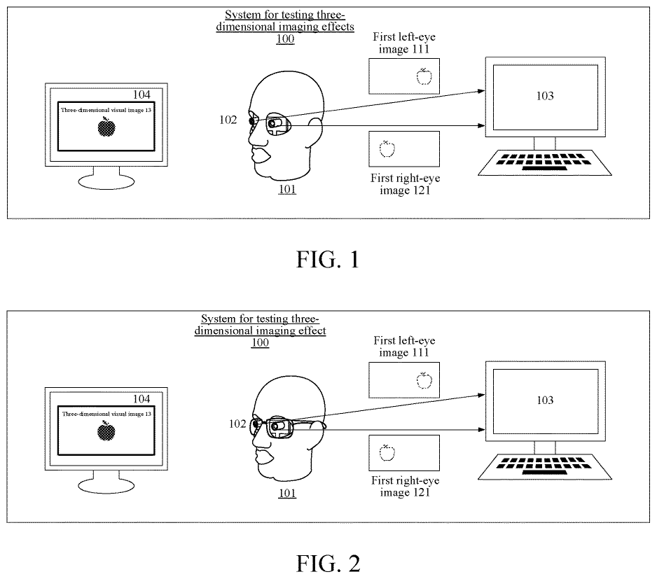

In some embodiments, the three-dimensional display device 104 is a display device using three-dimensional glasses. Specifically, the three-dimensional display device 104 is a device in which light emitted in a three-dimensional display process passes through the three-dimensional glasses to achieve a three-dimensional display effect. The three-dimensional glasses are further provided at the eye positions of the head model 101, and the three-dimensional glasses may be red-blue glasses, polarized glasses, or the like. A left lens of the three-dimensional glasses is configured to assist the left camera of the binocular camera in capturing a left-eye image, and a right lens of the three-dimensional glasses is configured to assist the right camera in capturing a right-eye image. The left-eye image is a two-dimensional image photographed by the camera from a left viewing angle, and the right-eye image is a two-dimensional image photographed by the camera from a right viewing angle. For example, FIG. 2 shows a head model provided with three-dimensional glasses.

In some embodiments, a three-dimensional display device is a display device using a three-dimensional helmet. Specifically, the three-dimensional display device 104 is a device in which light emitted in a three-dimensional display process passes through the three-dimensional helmet to achieve a three-dimensional display effect. The head model 101 wears the three-dimensional helmet. The three-dimensional helmet is configured to assist the left camera of the binocular camera in capturing a left-eye image, and is configured to assist the right camera in capturing a right-eye image. The left-eye image is a two-dimensional image photographed by the camera from a left viewing angle, and the right-eye image is a two-dimensional image photographed by the camera from a right viewing angle.

FIG. 1 shows that the computing component 103 is a hardware device independent of the head model 101. The computing component 103 is a computer device. The computer device may be at least one of a smartphone, a smart watch, a tablet computer, a vehicle-mounted terminal, a notebook computer, a wearable device, a smart television, an e-book reader, an MP3 player, an MP4 player, a laptop portable computer, and a desktop computer.

In some embodiments, the computing component 103 may alternatively be a miniature computing device, such as a central processing unit (CPU), a graphics processing unit (GPU), or a chip, and is disposed in an inner cavity of the head model 101.

In some embodiments, the three-dimensional display device 104 may be at least one of a theater hardware device, a tablet computer, a vehicle-mounted terminal, a notebook computer, a wearable device, a smart television, and a desktop computer.

In the foregoing embodiment, a scenario in which a real person views a three-dimensional visual image can be simulated by using the head model 101 and the binocular camera 102 located at the eye positions of the head model 101. The binocular camera 102 can collect objective data (the first left-eye and right-eye images), and the computing component 103 may subsequently evaluate a three-dimensional imaging effect based on the objective data, to quantify the three-dimensional imaging effect. In other words, in this application, reliance on subjective perceptions of actual viewers who have viewed the three-dimensional visual image is avoided. In addition, in this application, the three-dimensional imaging effect is evaluated based on the collected objective data, to provide objective reference for subsequent software and hardware improvement of the three-dimensional display device 104. In addition, this application provides a universal solution to support testing of an imaging capability of a wide range of three-dimensional display devices 104. An entire testing system is simple, requires no additional development and customization work, and can accurately and objectively evaluate a three-dimensional imaging effect under any evaluation standard.

In some embodiments, the head model 101 is disposed on a support, and an absolute position of the binocular camera 102 changes with a position change of the head model on the support. The position change includes at least one of a translational position change and a rotational position change. The translational position change refers to displacement of the head model 101 in one direction, and the rotational position change refers to rotation in at least one of a pitch angle, a yaw angle, and a roll angle of the head model 101. The support may be a swinging support imitating a human neck, or may be a support that imitates a human torso and that has a height equal to that of the human torso.

A change in the absolute position of the binocular camera 102 means that, when the position of the head model 101 changes, the binocular camera 102 remains stationary relative to the head model 101, and the position of the binocular camera 102 changes only with the position change of the head model 101. In this case, the binocular camera 102 does not move relative to the head model 101. This helps to control a single variable (the position of the head model on the support) when an imaging effect is tested. Only the single variable changes, so that a more scientifically rigorous relationship between the head position and the imaging effect can be obtained.

Scenarios in which real persons with different heights and different body postures view a three-dimensional visual image may be simulated by adjusting the support and/or the head model on the support, so that more complete imaging effect information of the three-dimensional display device can be obtained through a plurality of tests.

In some embodiments, the support is a movable support, and positions of the head model and the binocular camera are changed accordingly by moving the support. Scenarios in which a real person views a three-dimensional visual image at different positions may be simulated by moving the support, so that more complete imaging effect information of the three-dimensional display device can be obtained through a plurality of tests.

In some embodiments, the head model 101 is disposed on a horizontal slide rail. Scenarios in which a real person views a three-dimensional visual image at different positions may be simulated by changing the position of the head model on the horizontal slide rail, so that more complete imaging effect information of the three-dimensional display device can be obtained through a plurality of tests.

In some embodiments, the binocular camera 102 is provided with a baseline adjustment component. The baseline adjustment component is configured to adjust a horizontal baseline between the left camera and the right camera of the binocular camera 102.

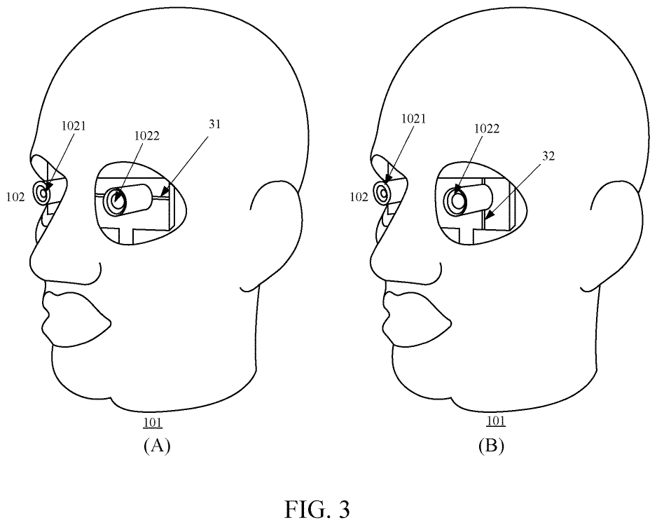

The baseline adjustment component may be implemented by using a structure such as a slide rail, a gear, or a rack. For example, a part (A) of FIG. 3 shows a horizontal slide rail 31 disposed between a left camera 1021 and a right camera 1022 of the binocular camera 102. The horizontal slide rail 31 is configured to adjust a horizontal baseline between the left camera 1021 and the right camera 1022 of the binocular camera 102.

Scenarios in which real persons with different interpupillary distances view a three-dimensional visual image may be simulated by changing the horizontal baseline of the binocular camera, so that more complete imaging effect information of the three-dimensional display device can be obtained through a plurality of tests.

In some embodiments, the binocular camera 102 is provided with a height adjustment component. The height adjustment component is configured to adjust a longitudinal height of the binocular camera 102 relative to the head model 101.

For example, a part (B) of FIG. 3 shows a longitudinal slide rail 32. The longitudinal slide rail 32 is configured to adjust a longitudinal height of the binocular camera 102 relative to the head model 101. During adjustment, the head model 101 may remain stationary, and only the binocular camera 102 moves along the longitudinal slide rail 32.

Scenarios in which real persons with different eye heights view a three-dimensional visual image may be simulated by changing the longitudinal height of the binocular camera relative to the head model, so that more complete imaging effect information of the three-dimensional display device can be obtained through a plurality of tests.

The horizontal slide rail 31 and the longitudinal slide rail 32 are merely examples for description. Both horizontal baseline adjustment and longitudinal height adjustment of the binocular camera 102 can be implemented by using a combination design of mechanical structures.

In some embodiments, at least one of the left camera and the right camera of the binocular camera 102 is provided with a pan-tilt component. The pan-tilt component is configured to adjust a photographing direction of the camera in at least one of up, down, left and right rotation directions. For example, the left camera of the binocular camera 102 corresponds to a first pan-tilt component, and the first pan-tilt component is configured to carry the left camera. In some embodiments, the first pan-tilt component is connected to a computing component, and the first pan-tilt component adjusts a photographing direction of the left camera based on a received instruction transmitted by the computing component. For example, the right camera of the binocular camera 102 corresponds to a second pan-tilt component, and the second pan-tilt component is configured to carry the right camera. In some embodiments, the second pan-tilt component is connected to the computing component, and the second pan-tilt component adjusts a photographing direction of the right camera based on a received instruction transmitted by the computing component. In some embodiments, the pan-tilt component is disposed in an inner cavity of the head model.

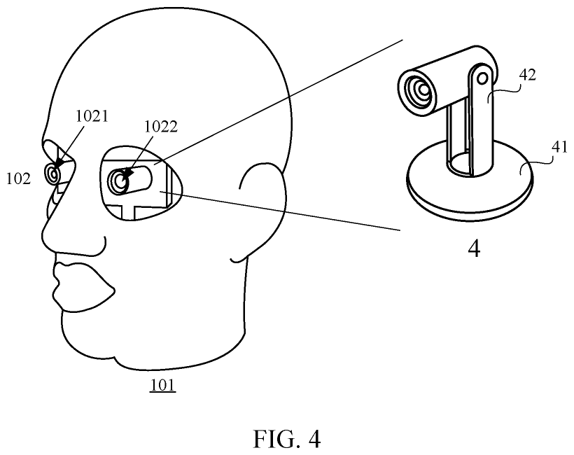

For example, FIG. 4 shows a pan-tilt component 4. Abase 41 of the pan-tilt component 4 allows the camera to rotate left and right. A support rod 42 of the pan-tilt component allows the camera to rotate up and down.

In some embodiments, the computing component 103 is configured to: identify a visual focus element in at least one of the first left-eye image 111 and the first right-eye image 121; and transmit, to the pan-tilt component 4, a control instruction for directing toward the visual focus element. The pan-tilt component 4 is configured to adjust a photographing direction of a camera toward the visual focus element based on the control instruction.

The visual focus element is an imaging element in the image. In some embodiments, the computing component 103 first performs image segmentation, and identifies an element occupying a largest area in the image as the visual focus element. In some embodiments, the computing component 103 performs image segmentation by using a segment-anything-model (SAM). For detailed introduction of the SAM model, refer to a web page (https://segment-anything.com/).

In some embodiments, the computing component 103 identifies, based on a preset image element, a matching imaging element from a captured image, and determines the matching imaging element as the visual focus element.

The pan-tilt component 4 is configured to adjust a photographing direction of the camera toward the visual focus element based on the control instruction, so that an image captured again by the binocular camera includes an imaging element corresponding to the visual focus element.

For example, the computing component 103 identifies the first left-eye image 111, to obtain a visual focus element which is an apple and obtain a coordinate position of the visual focus element in the first left-eye image 111. The computing component 103 identifies the first right-eye image 121, to obtain a visual focus element which is also an apple and obtain a coordinate position of the visual focus element in the first right-eye image 121. The computing component 103 transmits, to the pan-tilt component 4, a first control instruction for directing a photographing direction of the left camera toward the apple, and transmits, to the pan-tilt component 4, a second control instruction for directing a photographing direction of the right camera also toward the apple. The first control instruction is generated based on a first offset value, and the first offset value is an offset of a coordinate position of the visual focus element in the first left-eye image 111 relative to an image center. The second control instruction is generated based on a second offset value, and the second offset value is an offset of a coordinate position of the visual focus element in the first right-eye image 121 relative to an image center.

The pan-tilt component 4 is configured to adjust a photographing direction of the camera in at least one of up, down, left and right rotation directions, to simulate a scenario in which a real person focuses on a region of interest when viewing a three-dimensional visual image, thereby enabling testing of an imaging effect of the three-dimensional display device in such a scenario.

In some embodiments, periocular simulation components are fitted outside the left camera and the right camera. The periocular simulation components are configured to simulate tissues surrounding human eyes, eyelashes, and the like, so that an autostereoscopic display device identifies eye positions or a gaze position of the head model 101 through image identification, thereby implementing eye detection on the head model 101.

The pan-tilt component 4 can also be combined with the horizontal slide rail 31 and/or the longitudinal slide rail 32 to form a new embodiment, which is not limited.

In some embodiments, a client is installed on the computing component, and an interface of the client supports display of a field-of-view adjustment control of at least one of the left camera and the right camera of the binocular camera. The field-of-view adjustment control is configured to adjust a field of view (FOV) of at least one of the left camera and the right camera of the binocular camera.

In some embodiments, fields of view of the left camera and the right camera of the binocular camera both fall within a range of 60 degrees to 120 degrees, to simulate a scenario in which a three-dimensional visual image is viewed within a field of view of real eyes. In some embodiments, the client is a client supporting adjustment of camera parameters, and the client supports adjustment of photographing parameters of the camera.

In some embodiments, a client is installed on the computing component, an interface of the client supports display of a photographing speed adjustment control, and the photographing speed adjustment control is configured to adjust a photographing speed of at least one of the left camera and the right camera of the binocular camera.

In some embodiments, the left camera and the right camera of the binocular camera each capture 720 frames per second, to meet a requirement for high-speed photographing of a three-dimensional visual image. A delay error between the left camera and the right camera of the binocular camera is less than 1.4 milliseconds (ms), to ensure a requirement for synchronous photographing. In some embodiments, the client is a client supporting adjustment of camera parameters, and the client supports adjustment of photographing parameters of the camera.

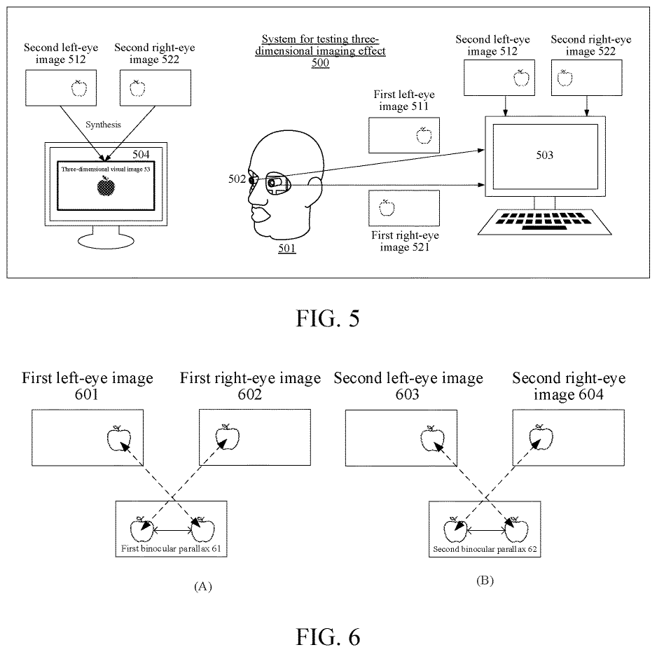

FIG. 5 shows a system for testing three-dimensional imaging effects according to an embodiment of this application. The system for testing three-dimensional imaging effects 500 includes: a head model 501, a binocular camera 502 provided at eye positions of the head model 501, and a computing component 503 connected to the binocular camera 502. In some embodiments, the binocular camera 502 is connected to the computing component 503 in a wired or wireless manner.

A three-dimensional display device 504 obtains a second left-eye image 512 and a second right-eye image 522, and the second left-eye image 512 and the second right-eye image 522 are two-dimensional images of the same scene. In some embodiments, the second left-eye image 512 is a two-dimensional image photographed through left-eye vision, and the second right-eye image 522 is a two-dimensional image photographed through right-eye vision. The three-dimensional display device 504 synthesizes the second left-eye image 512 and the second right-eye image 522, to obtain a three-dimensional visual image 53. The three-dimensional display device 504 presents the three-dimensional visual image 53.

In some embodiments, the three-dimensional display device 504 synthesizes the second left-eye image 512 and the second right-eye image 522 by using a three-dimensional (3D) modeling tool, to obtain the three-dimensional visual image 53. The 3D modeling tool may be 3D Studio MAX (which is often referred to as 3ds MAX or MAX for short, and is three-dimensional animation rendering and production software that is developed by Discreet company (later incorporated into Autodesk company) and that is based on a PC system), Blender (a cross-platform application that runs on Linux, macOS, and Windows systems. Compared with another 3D modeling tool, Blender has lower internal memory and driver requirements. An interface of Blender use OpenGL, to provide consistent user experience on all supported hardware and platforms), Maya (three-dimensional animation software produced by Autodesk company), or the like.

The binocular camera 502 photographs the three-dimensional visual image 53, to obtain a first left-eye image 511 and a first right-eye image 521. The binocular camera 502 transmits the photographed first left-eye image 511 and first right-eye image 521 to the computing component 503. The first left-eye image 511, the first right-eye image 521, the second left-eye image 512, and the second right-eye image 522 are images obtained by viewing the same three-dimensional scene. The first left-eye image 511 and the second left-eye image 512 are both images obtained by viewing the same three-dimensional scene from a left eye. The first left-eye image 511 and the second left-eye image 512 may be images obtained by viewing the same three-dimensional scene at the same position, or may be images obtained by viewing the same three-dimensional scene at different positions.

The first right-eye image 521 and the second right-eye image 522 are both images obtained by viewing the same three-dimensional scene from a right eye. The first right-eye image 521 and the second right-eye image 522 may be images obtained by viewing the same three-dimensional scene at the same position, or may be images obtained by viewing the same three-dimensional scene at different positions.

The computing component 503 further obtains the second left-eye image 512 and the second right-eye image 522. The computing component 503 computes an error between an image before synthesis and an image captured by the binocular camera, and the error is configured for evaluating an imaging effect of the three-dimensional display device. Specifically, the computing component 503 computes a value of an imaging parameter based on at least one of the first left-eye image 511 and the first right-eye image 521, to obtain a first value. The computing component 503 further computes a value of the imaging parameter based on at least one of the second left-eye image 512 and the second right-eye image 522, to obtain a second value. The imaging parameter is an image parameter of a formed image. In some embodiments, the imaging parameter includes an image parameter that can be obtained based on a single image. For example, the imaging parameter includes a pixel value, a contour of an object in the image, or the like. In some embodiments, the imaging parameter includes an image parameter that can computed based on at least two images. For example, the imaging parameter includes a binocular parallax. The computing component 503 computes an error between the first value and the second value, and the error is configured for evaluating an imaging effect of the three-dimensional display device.

Based on the embodiment shown in FIG. 5, an imaging effect of the three-dimensional display device is evaluated based on the imaging parameter error. In some embodiments, the imaging parameter error includes at least one of a binocular parallax error, a pixel value offset, and an object contour offset. The following describes in detail an evaluation method based on the imaging parameter error.

Based on the embodiment shown in FIG. 5, the first value includes a first binocular parallax, and the second value includes a second binocular parallax. The imaging parameter error includes a binocular parallax error. The binocular parallax error may be configured for measuring a degree of contribution of a three-dimensional display device to ghosting of a three-dimensional visual image. For example, a large binocular parallax error indicates that the three-dimensional display device makes a large contribution to the ghosting; and a small binocular parallax error indicates that the three-dimensional display device makes a small contribution to the ghosting.

The computing component 503 is further configured to: compute a binocular parallax between the first left-eye image 511 and the first right-eye image 521 to obtain a first binocular parallax; compute a binocular parallax between the second left-eye image 512 and the second right-eye image 522 to obtain a second binocular parallax; and compute a binocular parallax error between the first binocular parallax and the second binocular parallax. In some embodiments, an absolute value of a difference obtained by subtracting the second binocular parallax from the first binocular parallax is used as the binocular parallax error.

For example, the computing component 503 determines a first position of a first image element in the first left-eye image 511, determines a second position of the first image element in the first right-eye image 521, and determines a displacement between the first position and the second position in a horizontal direction as the first binocular parallax. The first image element is an element displayed or rendered in the three-dimensional visual image.

Refer to a part (A) of FIG. 6. The part (A) of FIG. 6 shows a position of an apple in a first left-eye image 601 and a position of an apple in a first right-eye image 602, and a horizontal displacement between the two positions. The horizontal displacement is a first binocular parallax 61.

The computing component 503 determines a third position of a second image element in the second left-eye image 512, determines a fourth position of the second image element in the second right-eye image 522, and determines a displacement between the third position and the fourth position in the horizontal direction as a second binocular parallax. The second image element is an element displayed or rendered in the three-dimensional visual image.

Refer to a part (B) of FIG. 6. The part (B) of FIG. 6 shows a position of an apple in a second left-eye image 603 and a position of an apple in a second right-eye image 604, and a horizontal displacement between the two positions. The horizontal displacement is a second binocular parallax 62.

In some embodiments, the first image element and the second image element are the same image element. For example, the first image element and the second image element are the same apple in the three-dimensional visual image.

In some embodiments, the first image element and the second image element may alternatively be different image elements. For example, the first image element is an apple in the three-dimensional visual image, and the second image element is a pear in the three-dimensional visual image.

The binocular parallax error may be configured for measuring a degree of contribution of a three-dimensional display device to ghosting of a three-dimensional visual image. A larger value of the binocular parallax error indicates a poorer imaging effect of the three-dimensional display device. A larger value of the binocular parallax error indicates that the three-dimensional display device is more likely to cause a ghosting effect. In this case, a synthesis effect of the three-dimensional display device is poor.

In an embodiment, if a computed binocular parallax error is less than a first parallax error threshold, an imaging effect is considered “normal”. If the computed binocular parallax error is greater than the first parallax error threshold and less than a second parallax error threshold, the imaging effect is considered “slightly deviated”. If the computed binocular parallax error is greater than the second parallax error threshold, the imaging effect is considered “greatly deviated”.

The first parallax error threshold is less than the second parallax error threshold, and values of the first parallax error threshold and the second parallax error threshold are both positive integers.

More segment thresholds may be set, and a segment into which the computed binocular parallax error falls is determined, to further precisely evaluate the imaging effect of the three-dimensional display device.

A binocular camera in related art is configured to photograph an image and further determine depth information of an object in the image. However, in this application, based on a first left-eye image and a first right-eye image that are photographed by the binocular camera, a binocular parallax between the first left-eye and right-eye images is computed, to further evaluate an imaging effect of the three-dimensional display device. The binocular camera in related art and the binocular camera in this application have different functions.

Based on the embodiment shown in FIG. 5, the first value includes a first pixel value of a target object, and the second value includes a second pixel value of the target object. The imaging parameter error includes a pixel value offset. The pixel value offset is configured for measuring a degree of contribution of a three-dimensional display device to blurring of a three-dimensional visual image. For example, a large pixel value offset indicates that the three-dimensional display device makes a large contribution to the blurring; and a small pixel value offset indicates that the three-dimensional display device makes a small contribution to the blurring.

The computing component 503 is configured to: determine a pixel value of a target object in the first left-eye image 511; determine a pixel value of the target object in the first right-eye image 521; and determine an average value of the pixel values of the target object in the first left-eye image 511 and the first right-eye image 521 as a first pixel value.

For example, an average value of pixel values of pixel points occupied by the target object in the first left-eye image 511 is determined as the pixel value of the target object in the first left-eye image 511. An average value of pixel values of pixel points occupied by the target object in the first right-eye image 521 is determined as the pixel value of the target object in the first right-eye image 521.

The computing component 503 is further configured to: determine a pixel value of the target object in the second left-eye image 512; determine a pixel value of the target object in the second right-eye image 522; and determine an average value of the pixel values of the target object in the second left-eye image 512 and the second right-eye image 522 as a second pixel value.

For example, an average value of pixel values of pixel points occupied by the target object in the second left-eye image 512 is determined as the pixel value of the target object in the second left-eye image 512. An average value of pixel values of pixel points occupied by the target object in the second right-eye image 522 is determined as the pixel value of the target object in the second right-eye image 522.

The computing component 503 is further configured to divide an absolute value of a difference obtained by subtracting the first pixel value from the second pixel value by the first pixel value, to obtain a pixel value offset.

The pixel value offset is configured for measuring a degree of contribution of a three-dimensional display device to blurring of a three-dimensional visual image. A larger pixel value offset indicates a poorer imaging effect of the three-dimensional display device. A larger pixel value offset, i.e., a large change in a pixel value, indicates that the three-dimensional display device is more likely to cause a blurring effect. In this case, a rendering effect of the three-dimensional display device is poor.

In an embodiment, if a computed pixel value offset is less than a first pixel offset threshold, an imaging effect is considered “normal”. If the computed pixel value offset is greater than the first pixel offset threshold and less than a second pixel offset threshold, the imaging effect is considered “slightly deviated”. If the computed pixel value offset is greater than the second pixel offset threshold, the imaging effect is considered “greatly deviated”.

The first pixel offset threshold is less than the second pixel offset threshold, and values of the first pixel offset threshold and the second pixel offset threshold are both positive integers.

More segment thresholds may be set, and a segment into which the computed pixel value offset falls is determined, to further precisely evaluate the imaging effect of the three-dimensional display device.

Based on the embodiment shown in FIG. 5, the first value includes first contour data of an object, and the second value includes second contour data of the object. The imaging parameter error includes a contour offset of the object. The contour offset may be configured for measuring a degree of contribution of a three-dimensional display device to deformation of the object in a three-dimensional visual image. For example, a large contour offset indicates that the three-dimensional display device makes a large contribution to the deformation of the object; and small contour offset indicates that the three-dimensional display device makes a small contribution to the deformation of the object.

The computing component 503 is configured to: synthesize a first three-dimensional image based on a first left-eye image 511 and a first right-eye image 521; and sketch a contour of a target three-dimensional object in the first three-dimensional image, to obtain a first contour. The computing component 503 makes p marked points (a large quantity of marked points) on the sketched first contour.

In some embodiments, the computing component randomly makes p marked points on the first contour. In some embodiments, p is a preset parameter. In some embodiments, p is obtained based on a preset proportion parameter and a quantity of pixels occupied by the first contour.

For example, the preset proportion parameter is l, and l is a decimal number from 0 to 1. The computing component determines, one by one, whether all pixel points on the first contour are marked. The computing component obtains a random number between 0 and 1. If the random number is less than 1, the pixel point is marked, and the pixel point is a marked point.

The computing component 503 is configured to: synthesize a second three-dimensional image based on the second left-eye image 512 and the second right-eye image 522; and sketch a contour of a target three-dimensional object in the second three-dimensional image, to obtain a second contour. The computing component 503 overlaps a centroid of the second contour with a centroid of the first contour. Then, the computing component 503 determines, one by one, whether all of the p marked points are on the second contour. If there are q marked points on the second contour, a contour offset of the target three-dimensional object is (p-q)/p. p and q are both positive integers.

The contour offset may be configured for measuring a degree of contribution of the three-dimensional display device to deformation of the object in the three-dimensional visual image. A larger contour offset indicates a poorer imaging effect of the three-dimensional display device. A larger contour offset indicates a higher degree of deformation of the object, and indicates that the three-dimensional display device is more likely to deform a rendered three-dimensional object. In this case, a synthesis and/or rendering effect of the three-dimensional display device are/is poor.

In an embodiment, if a computed contour offset is less than a first contour offset threshold, an imaging effect is considered “normal”. If the computed contour offset is greater than the first contour offset threshold and less than a second contour offset threshold, the imaging effect is considered “slightly deviated”. If the computed contour offset is greater than the second contour offset threshold, the imaging effect is considered “greatly deviated”.

The first contour offset threshold is less than the second contour offset threshold, and values of the first contour offset threshold and the second contour offset threshold are both positive integers.

More segment thresholds may be set, and a segment into which the computed contour offset falls is determined, to further precisely evaluate the imaging effect of the three-dimensional display device.

Based on the system for testing three-dimensional imaging effects shown in FIG. 1 or FIG. 5, the testing system further includes a signal trigger. In this embodiment of this application, the three-dimensional display device plays a three-dimensional visual video, the three-dimensional visual video includes a plurality of continuous three-dimensional visual images, and the binocular camera continuously photographs the three-dimensional visual video, to obtain a plurality of left-eye images and a plurality of right-eye images.

The signal trigger is configured to control the left camera and the right camera of the binocular camera to photograph synchronously.

In this embodiment of this application, a first port of the signal trigger is connected to the left camera through a first line, the first port of the signal trigger is connected to the right camera through a second line, the first line and the second line partially overlap or do not overlap, and the first port is configured to control the left camera and the right camera to photograph synchronously.

In this embodiment of this application, a second port of the signal trigger is connected to the computing component through a third line, and the second port is configured to supply power to the signal trigger.

In this embodiment of this application, when a real person views a three-dimensional visual image, both eyes of the real person view the three-dimensional vision image simultaneously. In this application, the signal trigger is configured to control the left and right cameras to photograph synchronously, to simulate a scenario in which both eyes of the real person view the three-dimensional visual image simultaneously. In addition, this application further provides a hardware line configuration centered around the “signal trigger”, to ensure synchronous photographing and power supply for the signal trigger.

In this embodiment of this application, the head model is a model with an empty interior. In some embodiments, the signal trigger is located inside the head model. In another embodiments, the head model is a solid model.

In this embodiment of this application, eye positions of the head model are hollow, to accommodate the binocular camera. In this embodiment of this application, a size of the head model is a standard size of a human head, and the three-dimensional display device is an autostereoscopic display device. Use of the model of the standard size of the human head facilitates human head capture by the autostereoscopic display device. The head model is configured for human head capture and eye capture by the autostereoscopic display device, to allow the autostereoscopic display device to synthesize a three-dimensional visual image.

In this embodiment of this application, the testing system further includes a fourth line connected between the binocular camera and the computing component, and the fourth line is configured for data transmission between the binocular camera and the computing component. For example, the binocular camera transmits a photographed image to the computing component through the fourth line. In some embodiments, the fourth line is a 10-gigabit network cable. In some embodiments, the head model is a model with an empty interior, and a part or all of the fourth line is deployed inside the head model.

In this embodiment of this application, after obtaining a first left-eye image and a first right-eye image, the computing component further performs an image preprocessing operation. The image preprocessing operation includes denoising, smoothing, alignment, and the like. The computing component performs the image preprocessing operation to improve quality and accuracy of the first left-eye image and the first right-eye image.

In this embodiment of this application, after performing the image preprocessing operation, the computing component further extracts features (related to a binocular parallax) from the preprocessed first left-eye image and first right-eye image. The features may be edges, corners, textures, and the like in the images. These features may provide information about a position and a shape of an object in a three-dimensional space.

In this embodiment of this application, the computing component matches the preprocessed first left-eye image and first right-eye image, and finds a point and/or region (that is, the first image element) corresponding to the first left-eye image and the first right-eye image by comparing features in the first left-eye image and the first right-eye image.

In this embodiment of this application, the computing component computes, based on a matching result, a horizontal displacement of the corresponding point and/or region in the first left-eye and right-eye images (that is, the first binocular parallax), and an amount of the horizontal displacement represents a position difference of an object in a depth direction.

In this embodiment of this application, the computing component further obtains a second left-eye image and a second right-eye image, and separately performs feature extraction on the second left-eye image and the second right-eye image to find a corresponding point or region (that is, the second image element). The computing component computes a horizontal displacement of the corresponding point or region in the second left-eye and right-eye images (that is, the second binocular parallax).

The Following Describes a Head Model Configured to Test a Three-Dimensional Imaging Effect Provided in this Application.

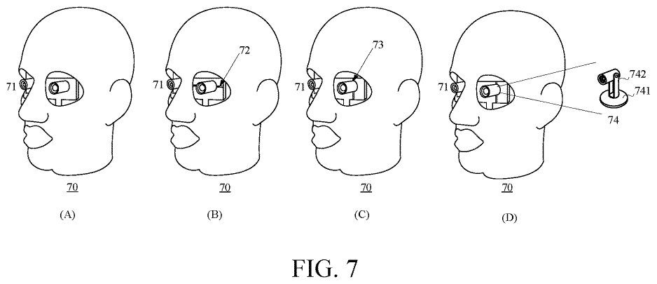

Refer to a part (A) of FIG. 7. The part (A) of FIG. 7 shows a head model 70 configured to test a three-dimensional imaging effect. A binocular camera 71 is provided at eye positions of the head model 70.

The binocular camera 71 is configured to photograph a three-dimensional visual image displayed or rendered on a three-dimensional display device, to obtain a first left-eye image and a first right-eye image, and the first left-eye image and the first right-eye image are configured for generating imaging effect information of the three-dimensional display device.

In this embodiment of this application, the head model 70 is disposed on a support, and an absolute position of the binocular camera 71 changes with a position change of the head model on the support. The position change includes at least one of a translational position change and a rotational position change. The translational position change refers to displacement of the head model 70 in one direction, and the rotational position change refers to rotation in at least one of a pitch angle, a yaw angle, and a roll angle of the head model 70. The support may be a swinging support imitating a human neck, or may be a support that imitates a human torso and that has a height equal to that of the human torso.

A change in the absolute position of the binocular camera 71 means that, when the position of the head model 70 changes, the binocular camera 71 remains stationary relative to the head model 70, and the position of the binocular camera 71 changes only with the position change of the head model 70. In this case, the binocular camera 71 does not move relative to the head model 70. This helps to control a single variable (the position of the head model on the support) when an imaging effect is tested. Only the single variable changes, so that a more scientifically rigorous relationship between the head position and the imaging effect can be obtained.

Scenarios in which real persons with different heights and different body postures view a three-dimensional visual image may be simulated by adjusting the support and/or the head model on the support, so that more complete imaging effect information of the three-dimensional display device can be obtained through a plurality of tests.

In some embodiments, the support is a movable support, and positions of the head model and the binocular camera are changed accordingly by moving the support. Scenarios in which a real person views a three-dimensional visual image at different positions may be simulated by moving the support, so that more complete imaging effect information of the three-dimensional display device can be obtained through a plurality of tests.

In some embodiments, the head model 70 is disposed on a horizontal slide rail. Scenarios in which a real person views a three-dimensional visual image at different positions may be simulated by changing the position of the head model on the horizontal slide rail, so that more complete imaging effect information of the three-dimensional display device can be obtained through a plurality of tests.

In some embodiments, the binocular camera 71 is provided with a baseline adjustment component. The baseline adjustment component is configured to adjust a horizontal baseline between a left camera and a right camera of the binocular camera 71.

The baseline adjustment component may be implemented by using a structure such as a slide rail, a gear, or a rack. For example, a part (B) of FIG. 7 shows a horizontal slide rail 72 disposed at the binocular camera 71, and the horizontal slide rail 72 is configured to adjust a horizontal baseline between the left camera and the right camera of the binocular camera 71.

In this embodiment of this application, the binocular camera 71 is provided with a height adjustment component. The height adjustment component is configured to adjust a longitudinal height of the binocular camera 71 relative to the head model 70.

For example, a part (C) of FIG. 7 shows a longitudinal slide rail 73. The longitudinal slide rail 73 is configured to adjust a longitudinal height of the binocular camera 71 relative to the head model 70. During adjustment, the head model 70 remains stationary, and only the binocular camera 71 moves along the longitudinal slide rail 73.

The horizontal slide rail 72 and the longitudinal slide rail 73 are merely examples for description. Both horizontal baseline adjustment and longitudinal height adjustment of the binocular camera 71 can be implemented by using a combination design of mechanical structures.

In some embodiments, at least one of the left camera and the right camera of the binocular camera 71 is provided with a pan-tilt component. The pan-tilt component is configured to adjust a photographing direction of the camera in at least one of up, down, left and right rotation directions.

For example, a part (D) of FIG. 7 shows a pan-tilt component 74. Abase 741 of the pan-tilt component 74 allows the camera to rotate left and right. A support rod 742 of the pan-tilt component 74 allows the camera to rotate up and down.

In this embodiment of this application, the pan-tilt component 74 is configured to adjust the photographing direction of the camera toward a visual focus element, and the visual focus element is a focus element identified in at least one of the first left-eye image and the first right-eye image.

For example, the first left-eye image is identified, to obtain a visual focus element which is an apple and obtain a coordinate position of the visual focus element in the first left-eye image. The first right-eye image is identified, to obtain a visual focus element which is also an apple and obtain a coordinate position of the visual focus element in the first right-eye image.

The pan-tilt component 74 is configured to adjust a photographing direction of the camera in at least one of up, down, left and right rotation directions, to simulate a scenario in which a real person focuses on a region of interest when viewing a three-dimensional visual image, thereby enabling testing of an imaging effect of the three-dimensional display device in such a scenario.

In some embodiments, periocular simulation components are fitted outside the left camera and the right camera. The periocular simulation components are configured to simulate tissues surrounding human eyes, eyelashes, and the like, so that an autostereoscopic display device identifies eye positions or a gaze position of the head model 70 through image identification, thereby implementing eye detection on the head model 70.

The pan-tilt component 74 can also be combined with the horizontal slide rail 72 and/or the longitudinal slide rail 73 to form a new embodiment, which is not limited.

In this embodiment of this application, the head model further includes a signal trigger. In this embodiment of this application, the three-dimensional display device plays a three-dimensional visual video, the three-dimensional visual video includes a plurality of continuous three-dimensional visual images, and the binocular camera continuously photographs the three-dimensional visual video, to obtain a plurality of left-eye images and a plurality of right-eye images.

The signal trigger is configured to control the left camera and the right camera of the binocular camera to photograph synchronously.

In this embodiment of this application, a first port of the signal trigger is connected to the left camera through a first line, the first port of the signal trigger is connected to the right camera through a second line, the first line and the second line partially overlap or do not overlap, and the first port is configured to control the left camera and the right camera to photograph synchronously.

In this embodiment of this application, a second port of the signal trigger is connected to the computing component through a third line, and the second port is configured to supply power to the signal trigger.

In this embodiment of this application, when a real person views a three-dimensional visual image, both eyes of the real person view the three-dimensional vision image simultaneously. In this application, the signal trigger is configured to control the left and right cameras to photograph synchronously, to simulate a scenario in which both eyes of the real person view the three-dimensional visual image simultaneously. In addition, this application further provides a hardware line configuration centered around the “signal trigger”, to ensure synchronous photographing and power supply for the signal trigger.

In this embodiment of this application, the head model is a model with an empty interior. In some embodiments, the signal trigger is located inside the head model. In another embodiments, the head model is a solid model.

In this embodiment of this application, eye positions of the head model are hollow, to accommodate the binocular camera. In this embodiment of this application, a size of the head model is a standard size of a human head, and the three-dimensional display device is an autostereoscopic display device. Use of the model of the standard size of the human head facilitates human head capture by the autostereoscopic display device. The head model is configured for human head capture and eye capture by the autostereoscopic display device, to allow the autostereoscopic display device to synthesize a three-dimensional visual image.

In this embodiment of this application, the interior of the head model is hollow, and a computing component is provided inside the head model. The computing component is configured to output imaging effect information of the three-dimensional display device based on the first left-eye image and the first right-eye image.

In this embodiment of this application, the head model further includes a fourth line connected between the binocular camera and the computing component, and the fourth line is configured for data transmission between the binocular camera and the computing component. For example, the binocular camera transmits a photographed image to the computing component through the fourth line. In some embodiments, the fourth line is a 10-gigabit network cable. In some embodiments, a part or all of the fourth line is deployed inside the head model.

The following describes a method for testing three-dimensional imaging effects provided in this application.

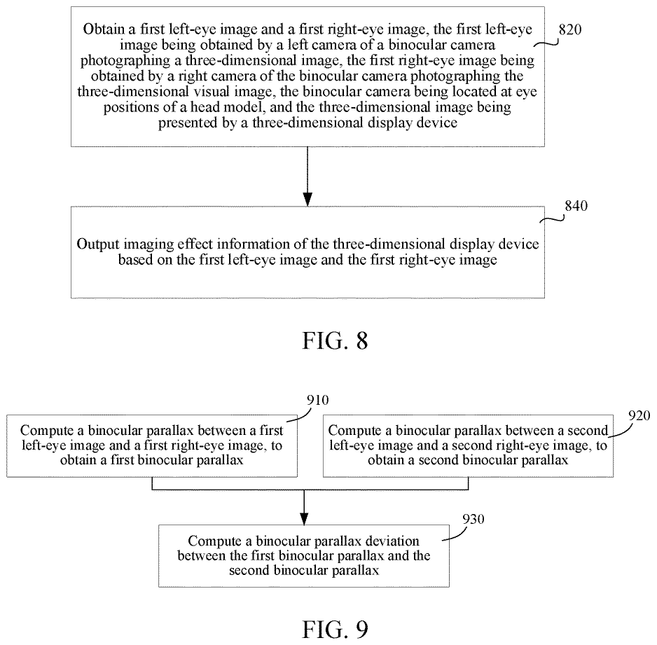

FIG. 8 is a flowchart of a method for testing three-dimensional imaging effect according to an embodiment of this application. An example in which the method is performed by the computing component 103 shown in FIG. 1 is used for description. The method includes the following operations.

Operation 820: Obtain a first left-eye image and a first right-eye image, the first left-eye image being obtained by a left camera of a binocular camera photographing a three-dimensional visual image, the first right-eye image being obtained by a right camera of the binocular camera photographing the three-dimensional visual image, the binocular camera being located at eye positions of a head model, and the three-dimensional visual image being displayed or rendered by a three-dimensional display device.

In some embodiments, the three-dimensional display device is an autostereoscopic display device. The autostereoscopic display device captures a position of the head model, and estimates eye positions of the head model. Alternatively, the autostereoscopic display device captures eye positions of the head model. The autostereoscopic display device performs three-dimensional image synthesis on the second left-eye image and the second right-eye image based on the eye positions, to obtain the three-dimensional visual image.

The autostereoscopic display device projects the three-dimensional visual image toward the eye positions.

In this application, the binocular camera is configured to simulate eyes of a viewer. The binocular camera photographs the three-dimensional visual image, to obtain the first left-eye image and the first right-eye image. The first left-eye image and the first right-eye image are two-dimensional images. The first left-eye image and the first right-eye image are configured for simulating a three-dimensional image captured by the eyes of the viewer. The first left-eye image is obtained by the left camera of the binocular camera photographing the three-dimensional visual image. The first right-eye image is obtained by the right camera of the binocular camera photographing the three-dimensional visual image.

Operation 840: Output imaging effect information of the three-dimensional display device based on the first left-eye image and the first right-eye image.

In this embodiment of this application, a computing component obtains the first left-eye image and the first right-eye image, and evaluates an imaging effect of the three-dimensional display device based on quality of the first left-eye and right-eye images. In some embodiments, the imaging effect of the three-dimensional display device is evaluated based on indicators such as a color, brightness, and definition of the first left-eye and right-eye images.

In this embodiment of this application, the computing component obtains the first left-eye and right-eye images and second left-eye and right-eye images, and evaluates the imaging effect of the three-dimensional display device based on a difference between the first left-eye and right-eye images and the second left-eye and right-eye images. The second left-eye and right-eye images are source data used by the three-dimensional display device to synthesize and output the three-dimensional visual image.

In this embodiment of this application, the computing component identifies a visual focus element in at least one of the first left-eye image and the first right-eye image, and transmits, to at least one pan-tilt component, a control instruction for directing toward the visual focus element. At least one of the left camera and the right camera of the binocular camera is provided with a pan-tilt component. The pan-tilt component is configured to adjust a photographing direction of the camera in at least one of up, down, left and right rotation directions.

In some embodiments, the computing component first performs image segmentation, and identifies an element occupying a largest area in the image as the visual focus element. In some embodiments, the computing component performs image segmentation by using a segment-anything-model (SAM).

In this embodiment of this application, a client is installed on the computing component, a field-of-view adjustment control of at least one of the left camera and the right camera of the binocular camera is displayed on an interface of the client, and the field-of-view adjustment control is configured to adjust a field of view of the camera.

In this embodiment of this application, a photographing speed adjustment control is displayed on the interface of the client, and the photographing speed adjustment control is configured to adjust a photographing speed of the camera.

Based on the embodiment shown in FIG. 8, the computing component evaluates the imaging effect of the three-dimensional display device based on differences between the images (the second left-eye and right-eye images) before synthesis and the images (the first left-eye and right-eye images) captured by the camera.

In this embodiment of this application, operation 840 includes: computing an error between a first value and a second value, the first value being a value of an imaging parameter obtained based on at least one of the first left-eye image and the first right-eye image, and the second value being a value of the imaging parameter obtained based on at least one of the second left-eye image and the second right-eye image.

An imaging parameter error includes a binocular parallax error. FIG. 9 is a flowchart of a method for testing three-dimensional imaging effects according to an embodiment of this application. An example in which the method is performed by the computing component 103 shown in FIG. 1 is used for description. The method includes the following operations.

Operation 910: Compute a binocular parallax between a first left-eye image and a first right-eye image, to obtain a first binocular parallax.

In an embodiment, the computing component determines a first position of a first image element in the first left-eye image, determines a second position of the first image element in the first right-eye image, and determines a displacement between the first position and the second position in a horizontal direction as the first binocular parallax. The first image element is an element displayed or rendered in the three-dimensional visual image.

The first image element may be a focus element in an image. For example, in a human-scene image, the first image element is a person in the image; and in a landscape image, the first image element is an element on which a camera focuses.

For example, the computing component determines a first position of an “apple” in the first left-eye image, determines a second position of an “apple” in the first right-eye image, and determines a quantity of pixels by which the first position is spaced from the second position as the first binocular parallax. The same image element is located on the right in the left-eye image and is located on the left in the right-eye image. In this case, “left” and “right” are relative to each other.

Refer to a part (A) of FIG. 6. The part (A) of FIG. 6 shows a position of an apple in a first left-eye image 601 and a position of an apple in a first right-eye image 602, and a horizontal displacement between the two positions. The horizontal displacement is a first binocular parallax 61.

Operation 920: Compute a binocular parallax between a second left-eye image and a second right-eye image, to obtain a second binocular parallax.

In an embodiment, the computing component determines a third position of a second image element in the second left-eye image, determines a fourth position of the second image element in the second right-eye image, and determines a displacement between the third position and the fourth position in the horizontal direction as the second binocular parallax. The second image element is an element displayed or rendered in the three-dimensional visual image.

The second image element may be a focus element in an image. For example, in a human-scene image, the second image element is a person in the image; and in a landscape image, the second image element is an element on which a camera focuses.

For example, the computing component determines a third position of a “pear” in the second left-eye image, determines a fourth position of the “pear” in the first right-eye image, and determines a quantity of pixels by which the third position is horizontally spaced from the fourth position as the second binocular parallax.

Refer to a part (B) of FIG. 6. The part (B) of FIG. 6 shows a position of an apple in a second left-eye image 603 and a position of an apple in a second right-eye image 604, and a horizontal displacement between the two positions. The horizontal displacement is a second binocular parallax 62.

Operation 930: Compute a binocular parallax error between the first binocular parallax and the second binocular parallax.

The second binocular parallax is subtracted from the first binocular parallax, to obtain the binocular parallax error. The binocular parallax error may be configured for measuring impact caused by a three-dimensional display device on whether ghosting of a three-dimensional visual image observed by a viewer occurs.

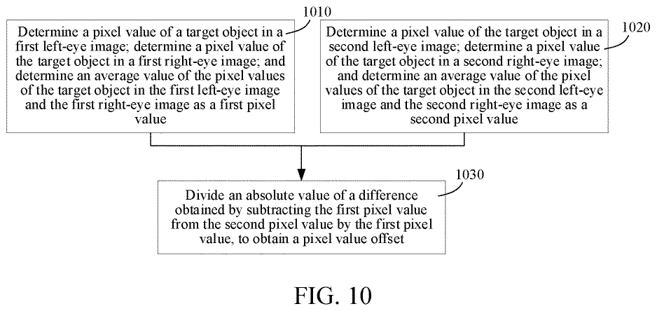

The imaging parameter error includes a pixel value offset. FIG. 10 is a flowchart of a method for testing three-dimensional imaging effects according to another embodiment of this application. An example in which the method is performed by the computing component 103 shown in FIG. 1 is used for description. The method includes the following operations.

Operation 1010: Determine a pixel value of a target object in a first left-eye image; determine a pixel value of the target object in a first right-eye image; and determine an average value of the pixel values of the target object in the first left-eye image and the first right-eye image as a first pixel value.

For example, a computing component detects that the first left-eye and right-eye images include the same “apple”. The computing component determines a pixel value of the “apple” in the first left-eye image and determines a pixel value of the “apple” in the first right-eye image. The computing component determines an average value of the pixel values of the “apple” in the first left-eye and right-eye images as the first pixel value.

In some embodiments, an average value of pixel values of pixel points occupied by the “apple” in the first left-eye image is determined as the pixel value of the “apple” in the first left-eye image. An average value of pixel values of pixel points occupied by the “apple” in the first right-eye image is determined as the pixel value of the “apple” in the first right-eye image.

Operation 1020: Determine a pixel value of the target object in a second left-eye image; determine a pixel value of the target object in a second right-eye image; and determine an average value of the pixel values of the target object in the second left-eye image and the second right-eye image as a second pixel value.

For example, the computing component determines a pixel value of the “apple” in the second left-eye image, and determines a pixel value of the “apple” in the second right-eye image. The computing component determines an average value of the pixel values of the “apple” in the second left-eye and right-eye images as the second pixel value.

In some embodiments, an average value of pixel values of pixel points occupied by the “apple” in the second left-eye image is determined as the pixel value of the “apple” in the second left-eye image. An average value of pixel values of pixel points occupied by the “apple” in the second right-eye image is determined as the pixel value of the “apple” in the second fright-eye image.

Operation 1030: Divide an absolute value of a difference obtained by subtracting the first pixel value from the second pixel value by the first pixel value, to obtain a pixel value offset.

For example, the first pixel value is f1, the second pixel value is f2, and the pixel value offset is redisplayed or rendered as:

$$y = \frac{\vert f 1 - f 2 \vert}{f 1} .$$

The pixel value offset is configured for measuring impact of a three-dimensional display device on whether blurring of an observed three-dimensional visual image occurs.

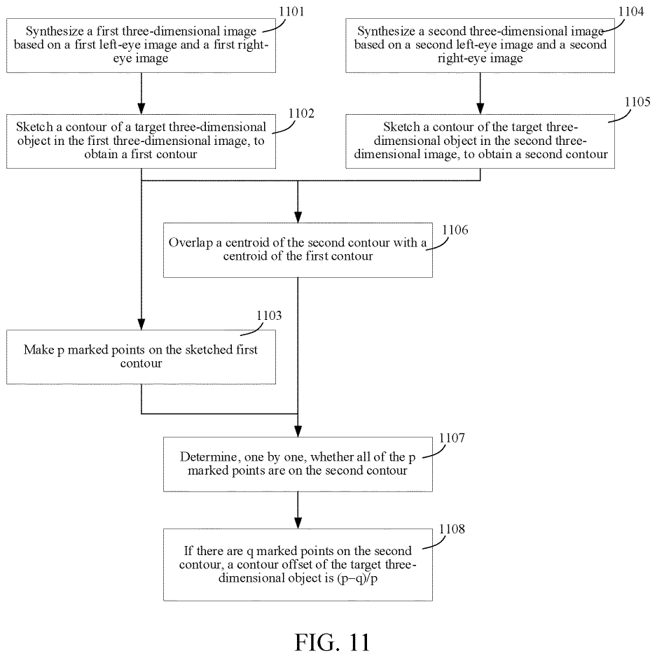

The imaging parameter error includes a contour offset. FIG. 11 is a flowchart of a method for testing three-dimensional imaging effects according to another embodiment of this application. An example in which the method is performed by the computing component 113 shown in FIG. 1 is used for description. The method includes the following operations.

Operation 1101: Synthesize a first three-dimensional image based on the first left-eye image and the first right-eye image.

The computing component synthesizes, by using a three-dimensional (3D) modeling tool, the first three-dimensional image based on the first left-eye image and the first right-eye image. The 3D modeling tool may be 3ds MAX, Blender, Maya, or the like.

Operation 1102: Sketch a contour of a target three-dimensional object in the first three-dimensional image, to obtain a first contour.

The computing component detects the contour of the target three-dimensional object in the first three-dimensional image, to obtain the first contour. The target three-dimensional object may be a focal object in an image. For example, if the image is a human image, the target three-dimensional object is a person; and if the image is a landscape image, the target three-dimensional object is an object in the image on which a camera focuses.

The first contour is a three-dimensional contour.

Operation 1103: Mark p marked points on the sketched first contour.

The computing component makes a large quantity of marked points on the first contour. In some embodiments, the computing component randomly makes p marked points on the first contour. In some embodiments, p is a preset parameter. In some embodiments, p is obtained based on a preset proportion parameter and a quantity of pixels occupied by the first contour.

For example, the preset proportion parameter is l, and l is a decimal number from 0 to 1. The computing component determines, one by one, whether all pixel points on the first contour are marked. The computing component randomly obtains a number between 0 and 1. If the number is less than 1, the pixel point is marked, and the pixel point is a marked point.

Operation 1104: Synthesize a second three-dimensional image based on a second left-eye image and a second right-eye image.

The computing component synthesizes, by using a 3D modeling tool, the second three-dimensional image based on the second left-eye image and the second right-eye image. The 3D modeling tool may be 3ds MAX, Blender, Maya, or the like.

Operation 1105: Sketch a contour of the target three-dimensional object in the second three-dimensional image, to obtain a second contour.

The computing component detects the contour of the target three-dimensional object in the second three-dimensional image, to obtain the second contour. The target three-dimensional object may be a focal object in an image. For example, if the image is a human image, the target three-dimensional object is a person; and if the image is a landscape image, the target three-dimensional object is an object in the image on which a camera focuses.

The second contour is a three-dimensional contour.

Operation 1106: Overlap a centroid of the second contour with a centroid of the first contour.

The computing component overlaps the centroid of the second contour with the centroid of the first contour by using the 3D modeling tool, to implement alignment between the second contour and the first contour.

Operation 1107: Determine, one by one, whether all of the p marked points are on the second contour.

The computing component determines, one by one, whether the p marked points made on the first contour are on the second contour.

Operation 1108: If there are q marked points on the second contour, a contour offset of the target three-dimensional object is (p-q)/p.

If q marked points in the p marked points can be found on the second contour, it is determined that the contour offset of the target three-dimensional object is (p-q)/p. The contour offset may be configured for measuring impact caused by the three-dimensional display device on deformation of the three-dimensional object observed by the viewer.

Based on embodiments shown in FIG. 9 to FIG. 11, to more accurately evaluate an imaging effect of the three-dimensional display device, the three-dimensional display device plays a three-dimensional visual video. One three-dimensional visual video includes a plurality of continuous three-dimensional visual images. The binocular camera continuously captures the three-dimensional visual video, to obtain a plurality of first left-eye images and a plurality of first right-eye images, and transmits the plurality of first left-eye images and the plurality of first right-eye images to the computing component.

The computing component further obtains a plurality of second left-eye images and a plurality of second right-eye images. Timestamps of the plurality of first left-eye images are in one-to-one correspondence with timestamps of the plurality of second left-eye images, and timestamps of the plurality of first right-eye images are in one-to-one correspondence with timestamps of the plurality of second right-eye images.

At a timestamp t1, the computing component computes a first value of an imaging parameter corresponding to the first left-eye and right-eye images, computes a second value of the imaging parameter corresponding to the second left-eye and right-eye images, and computes an error between the first value and the second value, which is denoted as a value error x1.

The imaging parameter is at least one of a binocular parallax, a pixel value offset, and a contour offset.

At a timestamp t2, the computing component computes a first value of an imaging parameter corresponding to the first left-eye and right-eye images, computes a second value of the imaging parameter corresponding to the second left-eye and right-eye images, and computes an error between the first value and the second value, which is denoted as a value error x2.

At a timestamp t3, the computing component computes a first value of an imaging parameter corresponding to the first left-eye and right-eye images, computes a second value of the imaging parameter corresponding to the second left-eye and right-eye images, and computes an error between the first value and the second value, which is denoted as a value error x3. The rest can be deduced by analogy.

The computing component 103 obtains a value error array, which is expressed as {x1, x2, x3, . . . xn}. If m value errors in the n value errors satisfy a condition, a score for the imaging effect of the three-dimensional display device is m/n.

An objective scoring standard is provided by scoring an imaging effect of a three-dimensional visual video displayed on the three-dimensional display device, to avoid using subjective evaluations of viewers to score the three-dimensional display device.

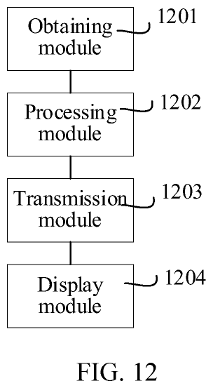

FIG. 12 is a block diagram of a structure of a three-dimensional imaging effect testing apparatus according to an embodiment of this application. The apparatus includes:
an obtaining module 1201, configured to obtain a first left-eye image and a first right-eye image, the first left-eye image being obtained by a left camera of a binocular camera photographing a three-dimensional visual image, the first right-eye image being obtained by a right camera of the binocular camera photographing the three-dimensional visual image, the binocular camera being located at eye positions of a head model, and the three-dimensional visual image being displayed or rendered by a three-dimensional display device; and
a processing module 1202, configured to output imaging effect information of the three-dimensional display device based on the first left-eye image and the first right-eye image.

In an embodiment, the processing module 1202 is further configured to compute a deviation between a first value and a second value, the first value being a value of an imaging parameter obtained based on at least one of the first left-eye image and the first right-eye image, and the second value being a value of the imaging parameter obtained based on at least one of the second left-eye image and the second right-eye image.

In an embodiment, the first value includes a first binocular parallax, and the second value includes a second binocular parallax. The processing module 1202 is further configured to: compute a binocular parallax between the first left-eye image and the first right-eye image to obtain a first binocular parallax; compute a binocular parallax between the second left-eye image and the second right-eye image to obtain a second binocular parallax; and compute a binocular parallax error between the first binocular parallax and the second binocular parallax.

In an embodiment, the processing module 1202 is further configured to: determine a first position of a first image element in the first left-eye image; determine a second position of the first image element in the first right-eye image; determine a displacement between the first position and the second position in a horizontal direction as the first binocular parallax, the first image element being an element displayed or rendered in the three-dimensional visual image;
determine a third position of a second image element in the second left-eye image; determine a fourth position of the second image element in the second right-eye image; and determine a displacement between the third position and the fourth position in the horizontal direction as the second binocular parallax, the second image element being an element displayed or rendered in the three-dimensional visual image.

In an embodiment, the processing module 1202 is further configured to identify a visual focus element in at least one of the first left-eye image and the first right-eye image. The apparatus further includes a transmission module 1203. The transmission module 1203 is configured to transmit, to at least one pan-tilt component, a control instruction for directing toward the visual focus element. At least one of the left camera and the right camera of the binocular camera is provided with a pan-tilt component. The pan-tilt component is configured to adjust a photographing direction of the camera in at least one of up, down, left and right rotation directions.

In an embodiment, the apparatus further includes a display module 1204. The display module 1204 is configured to display a field-of-view adjustment control of at least one of the left camera and the right camera of the binocular camera on an interface of a client, the field-of-view adjustment control being configured to adjust a field of view of the at least one camera.

In an embodiment, the display module 1204 is further configured to display a photographing speed adjustment control on an interface of a client, the photographing speed adjustment control being configured to adjust a photographing speed of at least one of the left camera and the right camera of the binocular camera.

In conclusion, a binocular camera provided at eye positions of the head model captures the three-dimensional visual image displayed or rendered by the three-dimensional display device, and then the computing component generates the imaging effect information of the three-dimensional display device based on the captured images (the first left-eye and right-eye images).

In other words, in this application, an imaging capability of the three-dimensional display device is evaluated based on objective data, to avoid evaluation based on subjective factors of viewers, and provide reference for subsequent software and hardware improvement of the three-dimensional display device.

In addition, this application provides a universal solution to support testing of an imaging capability of a wide range of three-dimensional display devices. The testing system is simple, requires no additional development and customization, and can accurately and objectively evaluate a three-dimensional imaging effect under any evaluation standard.

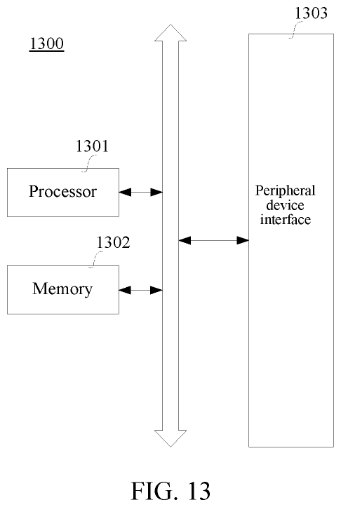

FIG. 13 is a block diagram of a structure of a computer device 1300 according to an embodiment of this application. The computer device 1300 may be the computing component in the foregoing embodiment. The computer device 1300 may be a portable mobile terminal, for example, a smartphone, a tablet computer, a moving picture experts group audio layer III (MP3) player, or a moving picture experts group audio layer IV (MP4) player. The computer device 1300 may alternatively be referred to user equipment, a portable terminal device, a head-mounted computer device, or the like.

Generally, the computer device 1300 includes a processor 1301 and a memory 1302.

The processor 1301 may include one or more processing cores, for example, a 4-core processor or an 8-core processor. The processor 1301 may be implemented in at least one hardware form of digital signal processing (DSP), a field-programmable gate array (FPGA), or a programmable logic array (PLA). The processor 1301 may alternatively include a main processor and a coprocessor. The main processor is a processor configured to process data in an awake state, and is also referred to as a central processing unit (CPU). The coprocessor is a low-power processor configured to process data in a standby state. In some embodiments, the processor 1301 may be integrated with a graphics processing unit (GPU). The GPU is configured to render and draw content that needs to be displayed on a display screen. In some embodiments, the processor 1301 may further include an artificial intelligence (AI) processor. The AI processor is configured to process computing operations related to machine learning.

The memory 1302 may include one or more computer-readable storage media. The computer-readable storage medium may be tangible and non-transitory. The memory 1302 may further include a high-speed random access memory and a non-volatile memory, for example, one or more disk storage devices or flash storage devices. In some embodiments, the non-transitory computer-readable storage medium in the memory 1302 is configured to store at least one instruction. The at least one instruction is configured to be executed by the processor 1301 to implement the method for testing three-dimensional imaging effects provided in embodiments of this application.

In some embodiments, the computer device 1300 may alternatively include a peripheral device interface 1303 and at least one peripheral device. Specifically, the peripheral device includes at least one of a radio frequency circuit, a display screen, a camera component, an audio circuit, and a power supply. A person skilled in the art may understand that the structure shown in FIG. 13 constitutes no limitation on the computer device 1300, and the computer device may include more or fewer components than those shown in the figure, or some components may be combined, or a different component deployment may be used.

An embodiment of this application further provides a computer device. The computer device includes a processor and a memory. The memory has at least one instruction, at least one program, a code set, or an instruction set stored therein. The at least one instruction, the at least one program, the code set, or the instruction set are loaded and executed by the processor to implement the method for testing three-dimensional imaging effects according to the foregoing method embodiments.

An embodiment of this application further provides a computer-readable storage medium, having a computer program stored therein, the computer program being executed by a computer device, to implement the method for testing three-dimensional imaging effects.

This application provides a computer program product or a computer program, including computer instructions, the computer instructions being stored in a computer-readable storage medium. A processor of a computer device reads the computer instructions from the computer-readable storage medium, and the processor executes the computer instructions, so that the computer device performs the method for testing three-dimensional imaging effects according to the foregoing method embodiments.

What is claimed is:

1. A system for testing three-dimensional imaging effects, comprising a head model, a binocular camera provided at eye positions of the head model, and a computing component connected to the binocular camera,
the binocular camera being configured to photograph a three-dimensional image displayed or rendered on a three-dimensional display device, to obtain a first left-eye image and a first right-eye image; and
the computing component being configured to output imaging effect information of the three-dimensional display device based on the first left-eye image and the first right-eye image.

2. The system according to claim 1, wherein the three-dimensional image is synthesized by the three-dimensional display device based on a second left-eye image and a second right-eye image; and
the computing component is configured to compute a deviation between a first value and a second value, the first value being a value of an imaging parameter obtained based on at least one of the first left-eye image and the first right-eye image, and the second value being a value of the imaging parameter obtained based on at least one of the second left-eye image and the second right-eye image.

3. The system according to claim 2, wherein the first value comprises a first binocular parallax, and the second value comprises a second binocular parallax; and
the computing component is configured to: compute a binocular parallax between the first left-eye image and the first right-eye image to obtain the first binocular parallax; compute a binocular parallax between the second left-eye image and the second right-eye image to obtain the second binocular parallax; and compute a binocular parallax deviation between the first binocular parallax and the second binocular parallax.

4. The system according to claim 3, wherein the computing component is configured to:
determine a first position of a first image element in the first left-eye image;
determine a second position of the first image element in the first right-eye image;
determine a displacement between the first position and the second position in a horizontal direction as the first binocular parallax, the first image element being an element displayed or rendered in the three-dimensional image;
determine a third position of a second image element in the second left-eye image;
determine a fourth position of the second image element in the second right-eye image; and
determine a displacement between the third position and the fourth position in the horizontal direction as the second binocular parallax, the second image element being an element displayed or rendered in the three-dimensional image.

5. The system according to claim 1, wherein the head model is disposed on a support, an absolute position of the binocular camera changes with a position change of the head model on the support, and the position change comprises at least one of a translational position change and rotational position change.

6. The system according to claim 1, wherein the binocular camera is provided with a baseline adjustment component; and
the baseline adjustment component is configured to adjust a horizontal baseline between a left camera and a right camera of the binocular camera.

7. The system according to claim 1, wherein at least one of the left camera and the right camera of the binocular camera is provided with a pan-tilt component; and
the pan-tilt component is configured to adjust a photographing direction of the camera in at least one of up, down, left and right rotation directions.

8. The system according to claim 7, wherein
the computing component is configured to: identify a visual focus element in at least one of the first left-eye image and the first right-eye image; and transmit, to the pan-tilt component, a control instruction for directing toward the visual focus element; and
the pan-tilt component is configured to adjust the photographing direction of the camera toward the visual focus element based on the control instruction.

9. The system according to claim 1, wherein a client is installed on the computing component, an interface of the client supports display of a field-of-view adjustment control of at least one of the left camera and the right camera of the binocular camera, and the field-of-view adjustment control is configured to adjust a field of view of the at least one camera.

10. The system according to claim 1, wherein a client is installed on the computing component, an interface of the client supports display of a photographing speed adjustment control, the photographing speed adjustment control is configured to adjust a photographing speed of at least one of the left camera and the right camera of the binocular camera.

11. The system according to claim 1, wherein the system further comprises a signal trigger, and the signal trigger is configured to control the left camera and the right camera of the binocular camera to photograph synchronously.

12. The system according to claim 11, wherein a first port of the signal trigger is connected to the left camera through a first line, the first port of the signal trigger is connected to the right camera through a second line, the first line and the second line partially overlap or do not overlap, and the first port is configured to control the left camera and the right camera to photograph synchronously.

13. The system according to claim 11, wherein a second port of the signal trigger is connected to the computing component through a third line, and the second port is configured to supply power to the signal trigger.

14. The system according to claim 11, wherein an interior of the head model is hollow; and the signal trigger is located inside the head model.

15. The system according to claim 1, wherein the three-dimensional display device is an autostereoscopic display device.

16. The system according to claim 1, wherein the three-dimensional display device is a display device using three-dimensional glasses, and the three-dimensional glasses are provided at the eye positions of the head model; or the three-dimensional display device is a display device using a three-dimensional helmet, and the head model wears the three-dimensional helmet.

17. The system according to claim 1, wherein the three-dimensional display device comprises a display screen, and a radial semi-conical lenticular grating disposed in front of the display screen.

18. A head model configured for testing three-dimensional imaging effects with a binocular camera being provided at eye positions of the head model, wherein the binocular camera is configured to photograph a three-dimensional image displayed or rendered on a three-dimensional display device to obtain a first left-eye image and a first right-eye image, and the first left-eye image and the first right-eye image are configured for generating imaging effect information of the three-dimensional display device.

19. A method for testing three-dimensional imaging effects, performed by a computing component and comprising:
obtaining a first left-eye image and a first right-eye image, the first left-eye image being obtained by a left camera of a binocular camera photographing a three-dimensional image, the first right-eye image being obtained by a right camera of the binocular camera photographing the three-dimensional image, the binocular camera being located at eye positions of a head model, and the three-dimensional image being displayed or rendered by a three-dimensional display device; and
outputting imaging effect information of the three-dimensional display device based on the first left-eye image and the first right-eye image.

20. The method according to claim 19, wherein the outputting imaging effect information of the three-dimensional display device based on the first left-eye image and the first right-eye image comprises:
computing an deviation between a first value and a second value, the first value being a value of an imaging parameter obtained based on at least one of the first left-eye image and the first right-eye image, the second value being a value of the imaging parameter obtained based on at least one of the second left-eye image and the second right-eye image, and the second left-eye image and the second right-eye image being used by the three-dimensional display device to synthesize the three-dimensional image.
